(19) United States
(12) Patent Application Publication
(10) Pub. No.: US 2025/0145800 A1
(43) Pub. Date: May 8, 2025

(54) SPHERICAL BORON NITRIDE PARTICLES, FILLER FOR RESINS, RESIN COMPOSITION, AND METHOD FOR PRODUCING SPHERICAL BORON NITRIDE PARTICLES

(71) Applicant: Denka Company Limited, Tokyo (JP)

(72) Inventors: Eri KANEKO, Chuo Tokyo (JP); Kenji MIYATA, Chuo Tokyo (JP); Michiharu NAKASHIMA, Chuo Tokyo (JP)

(21) Appl. No.: 18/838,215

(22) PCT Filed: Feb. 14, 2023
(86) PCT No.: PCT/JP2023/004891

§ 371 Date: Aug. 13, 2024

(30) Foreign Application Priority Data
Feb. 16, 2022 (JP) 2022-022210

(51) Int. Cl. C08K 7/18; C08K 3/38

(52) U.S. Cl. CPC C08K 7/18; C08K 3/38; C08K 2003/385; C08K 2201/003

(57) ABSTRACT

Provided are spherical boron nitride particles having a B₁ₛ/O₁ₛ ratio of 90 or and less, the B₁ₛ/O₁ₛ ratio being a ratio of a semiquantitative value calculated from an O₁ₛ peak intensity measured by X-ray photoelectron spectroscopy and a semiquantitative value calculated from a B₁ₛ peak intensity. For viscosities, measured at 25° C. with a shear rate being changed from 0.01 (1/s) to 100 (1/s), of a mixture in which 15 volume % of the spherical boron nitride particles are filled in an epoxy resin, a thixotropy index (T.I. index) represented by a ratio (η1/η2) of a viscosity η1 measured when the shear rate is 1 (1/s) and a viscosity η2 measured when the shear rate is 10 (1/s) is preferably 2 or less.

### TECHNICAL FIELD

The present invention relates to: spherical boron nitride particles; a filler for resins; a resin composition; and a method for producing spherical boron nitride particles.

### BACKGROUND

Hexagonal boron nitride (hereinafter referred to as “boron nitride”) has lubricity, high thermal conductivity, and insulation properties, etc., and is widely used in solid lubricants, mold release agents for molten gases and aluminum, etc., and in fillers for heat dissipating materials, and the like.

As boron nitride particles that exploit the lubricity and high thermal conductivity characteristics of boron nitride, Patent Document 1 discloses scaly, submicron boron nitride particles with high purity and high crystallinity and having a small diameter/thickness ratio (aspect ratio), and Patent Document 2 discloses submicron spherical boron nitride particles having a high degree of sphericity.

Patent Document 1: WO 2015/122378 A

Patent Document 2: WO 2015/122379 A

### SUMMARY OF INVENTION

Generally, when inorganic fillers are blended in resins, the fluidity of the resin compositions tends to decrease. The present inventors carried out thorough and diligent research into boron nitride particles that can realize excellent fluidity even when blended in a resin. As a result, it was discovered that, surprisingly, spherical boron nitride particles which have a prescribed surface state can provide a resin composition having excellent fluidity.

The present invention addresses a problem of providing: spherical boron nitride particles which can provide a resin composition having excellent fluidity; a filler for resins and a resin composition, the filler and the resin composition including spherical boron nitride particles; and a method for producing spherical boron nitride particles.

The present invention has the following embodiments.
[1] Spherical boron nitride particles having a B₁ₛ/O₁ₛ ratio of 90 or less, the B₁ₛ/O₁ₛ ratio being a ratio of a semiquantitative value calculated from an O₁ₛ peak intensity measured by X-ray photoelectron spectroscopy and a semiquantitative value calculated from a B₁ₛ peak intensity.
[2] The spherical boron nitride particles described in [1], wherein for viscosities, measured at 25° C. with a shear rate being changed from 0.01 (1/s) to 100 (1/s), of a mixture in which 15 volume % of the spherical boron nitride particles are filled in an epoxy resin, a thixotropy index (T.I. index) represented by a ratio (η1/η2) of a viscosity η1 measured when the shear rate is 1 (1/s) and a viscosity η2 measured when the shear rate is 10 (1/s) is 2 or less.
[3] The spherical boron nitride particles described in [1] or [2], wherein for viscosities, measured at 25° C. with a shear rate being changed from 100 (1/s) to 0.01 (1/s), of a mixture in which 15 volume % of the spherical boron nitride particles are filled in an epoxy resin, a thixotropy index (T.I. index) represented by a ratio (η1/η2) of a viscosity η1 measured when the shear rate is 1 (1/s) and a viscosity η2 measured when the shear rate is 10 (1/s) is 6 or less.
[4] The spherical boron nitride particles described in any one of [1] to [3], having a volume-based cumulative diameter (D50), evaluated by a laser diffraction/scattering method without performing a homogenization treatment, of 35 μm or less.
[5] The spherical boron nitride particles described in any one of [1] to [4], having an average circularity greater than 0.80.
[6] The spherical boron nitride particles described in any one of [1] to [5], wherein the semiquantitative value calculated from an O₁ₛ peak intensity measured by X-ray photoelectron spectroscopy is 0.6 or more.
[7] A filler for resins, the filler including the spherical boron nitride particles described in any one of [1] to [6].
[8] A resin composition including a resin and the spherical boron nitride particles described in any one of [1] to [6].
[9] A method for producing the spherical boron nitride particles described in any one of [1] to [6], the method including
   generating cavitation bubbles in a liquid including raw material spherical boron nitride particles and water.

According to the present invention, it is possible to provide: spherical boron nitride particles which can provide a resin composition having excellent fluidity; a filler for resins and a resin composition, the filler and the resin composition including spherical boron nitride particles; and a method for producing spherical boron nitride particles.

### DESCRIPTION OF EMBODIMENTS

Hereinafter, embodiments of the present invention will be described in detail. The present invention is not limited to the following embodiments and can be implemented with modifications added, as appropriate, as long as the effects of the present invention are not inhibited.

### Spherical Boron Nitride Particles

The spherical boron nitride particles according to the present embodiment have a B₁ₛ/O₁ₛ ratio of a semiquantitative value calculated from an O₁ₛ peak intensity measured by X-ray photoelectron spectroscopy and a semiquantitative value calculated from a B₁ₛ peak intensity (hereinafter also referred to simply as “B₁ₛ/O₁ₛ ratio”) of 90 or less.
Due to the B₁ₛ/O₁ₛ ratio of a semiquantitative value calculated from an O₁ₛ peak intensity measured by X-ray photoelectron spectroscopy and a semiquantitative value calculated from a B₁ₛ peak intensity being 90 or less, the spherical boron nitride particles according to the present embodiment can, when filled in a resin, provide a resin composition that has excellent fluidity.

Herein, “spherical” means that when observed at a 10,000× magnification using a scanning electron microscope, a circular or rounded particle shape is observed. Herein, a “B₁ₛ/O₁ₛ ratio of a semiquantitative value calculated from an O₁ₛ peak intensity measured by X-ray photoelectron spectroscopy and a semiquantitative value calculated from a B₁ₛ peak intensity” means a value determined by removing background by the Shirley method, calculating semiquantitative values calculated from B₁ₛ and O₁ₛ peak intensities, and calculating the ratio B₁ₛ/O₁ₛ.

Herein, the “Shirley method” means a method for determining a shape of a subtracted background with an assumption that there is no energy dependency with respect to inelastically scattered electrons which are a cause of the background, and further, that the number of electrons that scatter inelastically is proportionate to the peak intensity.
Spherical boron nitride particles for which the B₁ₛ/O₁ₛ ratio of a semiquantitative value calculated from an O₁ₛ peak intensity measured by X-ray photoelectron spectroscopy and a semiquantitative value calculated from a B₁ₛ peak intensity is 90 or less have a surface state that is excellent for dispersion in water. Furthermore, surprisingly, such spherical boron nitride particles, when mixed with a resin, improve the fluidity of the resin composition.
For the spherical boron nitride particles according to one embodiment, the B₁ₛ/O₁ₛ ratio of a semiquantitative value calculated from an O₁ₛ peak intensity measured by X-ray photoelectron spectroscopy and a semiquantitative value calculated from a B₁ₛ peak intensity is preferably 85 or less, more preferably 80 or less, preferably 75 or less, and further preferably 70 or less.
The lower limit of the B₁ₛ/O₁ₛ ratio is not particularly limited and may be 10 or more, may be 15 or more, and may be 20 or more.
Examples of methods for making the B₁ₛ/O₁ₛ ratio 90 or less include a method in which raw material spherical boron nitride particles are subjected to a cavitation treatment in a liquid that includes water. The raw material spherical boron nitride particles have a property of easily aggregating. However, when subjected to a cavitation treatment in a liquid that includes water, the aggregated state is broken with the primary particle shape (spherical) being maintained. A large amount of hydroxyl groups are introduced to the broken primary particle surfaces and the B₁ₛ/O₁ₛ ratio can easily be made 90 or less. It is thought that by making the B₁ₛ/O₁ₛ ratio 90 or less, it is possible to inhibit the broken spherical boron nitride particles from re-aggregating in the resin. The cavitation treatment is described in detail below.
By lengthening the cavitation treatment time, the B₁ₛ/O₁ₛ ratio can be made smaller.
By performing the treatment under conditions in which there are many cavitation bubbles or by lengthening the cavitation treatment time, surface hydroxyl groups increase and the B₁ₛ/O₁ₛ ratio can be made smaller.
By the research of the present inventors, it was discovered that spherical boron nitride particles treated by the foregoing method enable the fluidity of a resin to be raised more than in the case of fine particles that are broken by mechanical crushing.

For the spherical boron nitride particles according to one embodiment, a semiquantitative value calculated from an O₁ₛ peak intensity measured by X-ray photoelectron spectroscopy is preferably 0.6 or more, more preferably 0.65 or more, and further preferably 0.7 or more. Herein, a “semiquantitative value calculated from an O₁ₛ peak intensity measured by X-ray photoelectron spectroscopy” is a semiquantitative value calculated from an O₁ₛ peak intensity in an obtained spectrum after the background is removed therefrom by the Shirley method. Note that the upper limit value of the semiquantitative value calculated from the O₁ₛ peak intensity is not particularly limited and may be 5.0 or less, may be 4.0 or less, may be 3.0 or less, and may be 2.0 or less.

For the spherical boron nitride particles according to one embodiment, a semiquantitative value calculated from a B₁ₛ peak intensity measured by X-ray photoelectron spectroscopy is preferably less than 48.4, more preferably 48.35 or less, and further preferably 48.3 or less. Herein, a “semiquantitative value calculated from a B₁ₛ peak intensity measured by X-ray photoelectron spectroscopy” is a semiquantitative value calculated from a B₁ₛ peak intensity in an obtained spectrum after the background is removed therefrom by the Shirley method.

For the spherical boron nitride particles according to one embodiment, for viscosities, measured at 25° C. with a shear rate being changed from 0.01 (1/s) to 100 (1/s), of a mixture in which 15 volume % of the spherical boron nitride particles are filled in an epoxy resin, a thixotropy index (T.I. index, hereinafter also referred to as “T.I. index_{(0.01-100)}”) represented by a ratio (η1/η2) of a viscosity η1 measured when the shear rate is 1 (1/s) and a viscosity η2 measured when the shear rate is 10 (1/s) is preferably 2 or less, more preferably 1.8 or less, further preferably 1.6 or less, even further preferably 1.4 or less, and particularly preferably 1.2 or less.

An epoxy resin including the spherical boron nitride particles according to one embodiment has the low thixotropy index (T.I. index) described above, and therefore, has excellent fluidity.
The lower limit value of the T.I. index_{(0.01-100)} is preferably as close to one as possible.

For the spherical boron nitride particles according to one embodiment, for viscosities, measured at 25° C. with a shear rate being changed from 100 (1/s) to 0.01 (1/s), of a mixture in which 15 volume % of the spherical boron nitride particles are filled in an epoxy resin, a thixotropy index (T.I. index, hereinafter also referred to as “T.I. index_{(100-0.01)}”) represented by a ratio (η1/η2) of a viscosity η1 measured when the shear rate is 1 (1/s) and a viscosity η2 measured when the shear rate is 10 (1/s) is preferably 6 or less, more preferably 5.6 or less, further preferably 5.2 or less, even further preferably 4.8 or less, and particularly preferably 4.6 or less.

An epoxy resin including the spherical boron nitride particles according to one embodiment has the above-mentioned low thixotropy index (T.I. index) for viscosities when the shear rate is changed from a high shear rate to a low shear rate, and therefore, has excellent fluidity.
The lower limit value of the T.I. index_{(100-0.01)} is preferably as close to one as possible.

Herein, the method for measuring the “thixotropy index (T.I. index)” is as described below. That is, 15 volume % of the spherical boron nitride particles are filled in an epoxy resin by a publicly-known method to obtain a mixture (resin composition). A dynamic viscoelasticity measuring device is used on the obtained mixture to measure, at 25° C., the viscosity when (1) the shear rate is changed from 0.01 (1/s) to 100 (1/s) or (2) when the shear rate is changed from 100 (1/s) to 0.01 (1/s). The thixotropy index (T.I. index) for measured viscosities is obtained as a ratio (η1/η2) of a viscosity η1 measured when the shear rate is 1 (1/s) and a viscosity η2 measured when the shear rate is 10 (1/s).

For a mixture (resin composition) filled with the spherical boron nitride particles according to one embodiment, the thixotropy index (T.I. index) is close to 1 both when the shear rate is changed from a low shear rate to a high shear rate and when the shear rate is changed from a high shear rate to a low shear rate, that is, said mixture has excellent fluidity.

For the spherical boron nitride particles according to one embodiment, the volume-based cumulative diameter (D50), evaluated by a laser diffraction/scattering method without performing a specific dispersion treatment, for example, a homogenization treatment (that is, without applying any external force), is preferably 35 μm or less, more preferably 33 μm or less, further preferably 32 μm or less, even further preferably 30 μm or less, and particularly preferably 28 μm or less. Note that the lower limit of the volume-based cumulative diameter (D50), evaluated by a laser diffraction/scattering method without performing a homogenization treatment (that is, without applying any external force), is not particularly limited and may be 5 μm or more, may be 10 μm or more, and may be 15 μm or more.

Herein, “volume-based cumulative diameter (D50)” means a particle diameter corresponding to a cumulative value of 50% in a volume-based cumulative particle size distribution measured by using a laser diffraction/scattering method (refraction index: 1.7). The cumulative particle size distribution is represented by a distribution curve with the particle diameter (μm) on the horizontal axis and the cumulative value (%) on the vertical axis.
Irrespective of not performing a homogenization treatment, the spherical boron nitride particles according to one embodiment have a volume-based cumulative diameter (D50), evaluated by a laser diffraction/scattering method, which is small, being 30 μm or less. That is, the spherical boron nitride particles according to one embodiment, even without having to perform a treatment such as a homogenization treatment, have a characteristic wherein particles are intrinsically smaller and the proportion thereof in primary particle form is higher than that in secondary particle form. The spherical boron nitride particles according to one embodiment contribute to an improvement in fluidity of mixtures (resin compositions) in which the spherical boron nitride particles are filled. With spherical boron nitride particles having a B₁ₛ/O₁ₛ ratio exceeding 90, it is difficult to realize such a volume-based cumulative diameter (D50).
The spherical boron nitride particles according to the present embodiment can be rendered as smaller particles by further performing a homogenization treatment. For the spherical boron nitride particles according to one embodiment, the volume-based cumulative diameter (D50), evaluated by a laser diffraction/scattering method after performing a homogenization treatment (conditions: 300 W, 90 sec.) in ethanol, is preferably 0.6 μm or less, more preferably 0.58 μm or less, and further preferably 0.56 μm or less. Note that the lower limit of the volume-based cumulative diameter (D50), evaluated by a laser diffraction/scattering method after performing a homogenization treatment (conditions: 300 W, 90 sec.), is not particularly limited and may be 0.1 μm or more, may be 0.2 μm, and may be 0.3 μm or more.

For the spherical boron nitride particles according to one embodiment, an average circularity greater than 0.70 is preferable, with 0.725 or more being more preferable, 0.75 or more being further preferable, 0.775 or more being even further preferable, and 0.80 or more being particularly preferable. Note that the upper limit of the average circularity is not particularly limited and may be 1 or less and may be 0.95 or less.

Herein, “average circularity” indicates a value calculated as described below.
Image analysis software (for example, product name: “MacView” manufactured by Mountech Co., Ltd.) is used to perform image analysis on an image (magnification: 10,000×, image resolution: 1280×1024 pixels) of boron nitride particles captured by using a scanning electron microscope (SEM), to calculate a projected area (S) and perimeter (L) of the boron nitride particles. The projected area (S) and perimeter (L) are used to determine the circularity in accordance with the following formula:

Circularity=4πS/L²

The average value of circularities determined for 100 arbitrarily selected boron nitride particles is defined as the average circularity.

The spherical boron nitride particles according to one embodiment have a characteristic of having a high average circularity. Having a high average circularity contributes to an improvement in the fluidity of mixtures (resin compositions) in which the spherical boron nitride particles according to one embodiment are filled.

### Use

The spherical boron nitride particles can provide a resin composition having excellent fluidity, and therefore, can be favorably used as a filler for resins.

### Production Method

The method for producing the spherical boron nitride particles according to the present embodiment includes generating cavitation bubbles in a liquid including raw material spherical boron nitride particles and water.

### Raw Material Spherical Boron Nitride Particles

The raw material spherical boron nitride particles are preferably produced by the method disclosed in Patent Document 2. That is, the raw material spherical boron nitride particles can be obtained by reacting ammonia and a boric acid ester at an ammonia/boric acid ester molar ratio of 1-10 in an inert gas stream at 750° C. or higher for up to 30 seconds, then performing a heat treatment for at least one hour at 1000-1600° C. in an atmosphere of ammonia gas or a mixed gas of ammonia gas and an inert gas, and thereafter, further firing for 0.5 hours or more in an inert gas atmosphere at 1800-2200° C.
Examples of the boric acid ester include trimethyl borate.

The volume-based cumulative diameter (D50) of the raw material spherical boron nitride particles, evaluated by a laser diffraction/scattering method (method

described later in paragraph [0034] (Particle size distribution 2)), may be 0.01 μm or more, 0.05 μm or more, 0.1 μm or more, 0.2 μm or more, 0.3 μm or more, or 0.4 μm or more, and from the perspective of improving dielectric breakdown characteristics of a heat dissipation member, may be 1 μm or less, 0.9 μm or less, 0.8 μm or less, or 0.7 μm or less. The volume-based cumulative diameter (D50) of the raw material spherical boron nitride particles is preferably 0.01-1.0 μm and more preferably 0.3-0.8 μm.

The average circularity of the raw material spherical boron nitride particles is preferably 0.8 or more and more preferably 0.87 or more. The methods for measuring the volume-based cumulative diameter (D50) and average circularity are as described above.

### Cavitation Bubbles

In the method for producing spherical boron nitride particles according to the present embodiment, the raw material spherical boron nitride particles described above are put in in a liquid including water (preferably in water) and cavitation bubbles are generated in the liquid.
Herein, “cavitation bubbles” means bubbles that are generated by a liquid that vaporizes when a low pressure state is reached.
By generating cavitation bubbles in a liquid including spherical boron nitride particles and water, expansion and contraction forces due to pressure differences in bubbles generated by cavitation break down secondary particles of the spherical boron nitride particles to primary particles, and at the same time, the surface state of the particles undergoes a change such as an increase in the abundance ratio of hydroxyl groups.
The cavitation bubbles can be generated by using a commercially available device that generates cavitation bubbles by a foaming phenomenon in a liquid by a pressure reduction or ultrasonic waves. The cavitation bubbles are preferably generated by using a commercially available powder suction continuous dissolution and dispersion device, and circulating the liquid when performing the treatment is particularly preferable. Powder suction continuous dissolution and dispersion devices generally have a mechanism for generating a flow velocity by a stirring blade, and the rotation speed of the stirring blade is preferably 2000-10000 rpm, more preferably 4000-9000 rpm, further preferably 4500-8000 rpm, even further preferably 5000-8000 rpm, and particularly preferably 6000-7200 rpm.
By expansion and contraction forces due to pressure differences in bubbles generated by the cavitation, secondary particles are broken down to primary particles, and at the same time, the surface state of the particles undergoes a change such as an increase in the abundance ratio of hydroxyl groups.
In one embodiment, with the number of times that the cavitation treatment is performed calculated from the discharge amount and the rotation speed (rpm) of the stirrer blade of the device, the treatment for generating cavitation bubbles is preferably performed 50 times or more, more preferably 100 times or more, and further preferably 150 times or more. In the treatment for generating cavitation bubbles, by performing the treatment for generating cavitation bubbles 50 times or more, the B₁ₛ/O₁ₛ ratio can easily be made 90 or less.
Spherical boron nitride particles in which a B₁ₛ/O₁ₛ ratio of a semiquantitative value calculated from an O₁ₛ peak intensity measured by X-ray photoelectron spectroscopy and a semiquantitative value calculated from a B₁ₛ peak intensity is 90 or less are obtained.

In the method for producing spherical boron nitride particles according to the present embodiment, the liquid used in the production may be a liquid consisting of an organic solvent such as ethanol, or the like, and may be a mixed solution containing water and an organic solvent.

In the case of a mixed solution comprising water and an inorganic solvent, the content of the water in the mixed solution is preferably 80 mass % or more, more preferably 90 mass % or more, further preferably 95 mass % or more, and particularly preferably, the mixed solution consists of water.

The liquid used in production preferably comprises the spherical boron nitride particles at 5-30 weight %, more preferably at 5-20 weight %, further preferably at 5-15 weight %, even further preferably at 5-10 weight %, and particularly preferably at 8-10 weight %.

### Filler for Resins

A filler for resins according to the present embodiment includes the spherical boron nitride particles described above. The spherical boron nitride particles are as described above.
Examples of resins in which the filler for resins according to the present embodiment is filled include epoxy resins, silicone resins, phenol resins, melamine resins, urea resins, unsaturated polyesters, fluororesins, polyamides such as polyimide, polyamideimide, and polyetherimide, etc., polyesters such polybutylene terephthalate and polyethylene terephthalate, etc., polyphenylene ethers, polyphenylene sulfides, fully aromatic polyesters, polysulfones, liquid crystal polymers, polyethersulfones, polycarbonates, maleimide-modified resins, ABS resins, AAS (acrylonitrile-acrylic rubber/styrene) resins, and AES (acrylonitrile/ethylene/propylene/diene rubber-styrene) resins, etc. The resin preferably includes one or more types selected from the above, and more preferably is an epoxy resin.
The filler for resins according to the present embodiment is added so that the content of the spherical boron nitride particles in the resin composition is preferably 5-80 volume %. When added so that the content of the spherical boron nitride particles in the resin composition is 5-30 volume %, more preferably 10-25 volume %, and further preferably 15-20 volume %, a resin composition having a higher fluidity is obtained. When the filler for resins according to the present embodiment is added so that the content of the spherical boron nitride particles in the resin composition is 50-80 volume %, more preferably 60-80 volume %, and further preferably 70-80 volume %, a resin composition having a higher thermal conductivity is obtained. In one embodiment, the filler for resins is added so that the content of the spherical boron nitride particles in the resin composition is more than 5 volume % and 20 volume % or less.

### Resin Composition

The resin composition according to the present embodiment includes a resin and the spherical boron nitride particles described above.
Examples of the resin include epoxy resins, silicone resins, phenol resins, melamine resins, urea resins, unsaturated polyesters, fluororesins, polyamides such as polyimide, polyamideimide, and polyetherimide, etc., polyesters such as polybutylene terephthalate and polyethylene terephthalate, etc., polyphenyelene ethers, polyphenylene sulfides, fully aromatic polyesters, polysulfones, liquid crystal polymers, polyethersulfones, polycarbonates, maleimide-modified resins, ABS resins, AAS (acrylonitrile-acrylic rubber/styrene) resins, and AES (acrylonitrile/ethylene/propylene/diene rubber-styrene) resins, etc. The resin preferably includes one or more types selected from the above, and more preferably is an epoxy resin.

The content of the spherical boron nitride particles in the resin composition is 5-80 volume %. From the perspective of fluidity, the content of the spherical boron nitride particles in the resin composition is preferably 5-30 volume %, more preferably 10-25 volume %, and further preferably 15-20 volume %. In one embodiment, the content of the spherical boron nitride particles in the resin composition is more than 5 volume % and 20 volume % or less. From the perspective of thermal conductivity, the content of the spherical boron nitride particles in the resin composition is 50-80 volume %, more preferably 60-80 volume %, and further preferably 70-80 volume %. In one embodiment, the content of the spherical boron nitride particles in the resin composition is more than 70 volume % and 80 volume % or less.

The following components may be blended as necessary in the resin composition as other additives. Examples of other additives include: as a stress-reducing agent, rubber substances such as silicone rubbers, polysulfide rubbers, acrylic rubbers, butadiene-based rubbers, styrene-based block copolymers, or saturated elastomers, etc., resinous substances such as various kinds of thermoplastic resins, silicone resins, etc., and furthermore, resins such as epoxy resins and phenol resins partially or wholly modified by amino silicone, epoxy silicone, alkoxy silicone, or the like; as a flame retardant promoter, Sb₂O₃, Sb₂O₄, Sb₂O₅, etc.; as a flame retardant, halogenated epoxy resins, phosphorus compounds, etc.; and as a colorant, carbon black, iron oxide, dyes, pigments, etc.

The resin composition can be produced by stirring, dissolving, mixing, and dispersing prescribed amounts of the foregoing materials. As devices for mixing, stirring, and dispersing, etc., the foregoing mixtures, it is possible to use a grinding machine, a three-roller miller, a ball mill, a planetary mixer, etc., provided with a device for stirring and heating. Further, the foregoing devices may be used in combination, as appropriate.

### EXAMPLES

The present invention shall be explained in more detail by referring to the examples below, but interpretation of the present invention is not limited by these examples.

The raw material spherical boron nitride particles were fabricated by the following procedure.
(1) A reaction tube (quartz tube) set in a resistance heating furnace was heated to increase the temperature to 1150° C. Nitrogen gas was passed through trimethyl borate and then introduced to the reaction tube to introduce trimethyl borate into the reaction tube. Next, ammonia gas was introduced into the reaction tube directly. The molar ratio (ammonia/trimethyl borate) of the amount of ammonia introduced with respect to the amount of trimethyl borate introduced was set so as to be 1.8. The trimethyl borate and the ammonia were reacted to obtain a boron nitride particle precursor (white powder).
(2) The obtained boron nitride particle precursor was put into a crucible set in a resistance heating furnace and made of boron nitride, and nitrogen gas and ammonia gas were separately introduced into the reaction tube at respective flow rates of 10 L/minute and 15 L/minute. The reaction tube was heated for five hours at 1500° C. to obtain a second precursor.
(3) The obtained second precursor was put into a crucible made of boron nitride and was heated for five hours at 2000° C. in an induction heating furnace in a nitrogen atmosphere to obtain spherical boron nitride particles.
   The volume-based cumulative diameter (D50) of the raw material spherical boron nitride particles, evaluated by a laser diffraction/scattering method, was 0.62 μm and the average circularity thereof was 0.87.

### Examples 1-4 and Comparative Example 1

The spherical boron nitride particles were mixed in 1000 cc of ion-exchanged water so as to be 10 weight % thereof. For Examples 1-4, a powder suction continuous dissolution and dispersion device (“Jet Paster”, model number: JPSS, manufactured by Nihon Spindle Manufacturing Co., Ltd.) was used to perform a cavitation treatment on the obtained aqueous solutions under the conditions shown in Table 1. A cavitation treatment was not performed for Comparative Example 1.
In Table 1, “Times treated” is the number of times a treated solution passes the stirring blade and is calculated form the rotation speed (rpm) of the stirring blade of the powder suction continuous dissolution and dispersion device and the discharge amount per rotation.
After the cavitation treatment, the liquid was filtered and dried and the spherical boron nitride particles were recovered.

### Measurement

The physical properties described below were measured for the spherical boron nitride particles obtained in Examples 1-4 and Comparative Example 1. The results are shown in Table 1.
(B₁ₛ/O₁ₛ ratio)
For the spherical boron nitride particles according to Examples 1-4 and Comparative Example 1, the background was removed, by the Shirley method, from a spectrum measured using an X-ray photoelectron spectrometer (“K-Alpha photoelectron spectrometer” manufactured by Thermo Fisher Scientific Inc., AI-X-ray source with monochromator, measurement region: 400×200 μm), semiquantitative values were calculated from the B₁ₛ and O₁ₛ peak intensities, and the B₁ₛ/O₁ₛ ratio was determined.

### Particle Size Distribution 1

For each of the spherical boron nitride particles according to Examples 1-4 and Comparative Example 1, 0.1 g thereof was dispersed in 80 mL of ethanol and, without carrying out a treatment by a homogenizer, a volume-based particle size distribution was measured by a laser diffraction/scattering-method particle size distribution measuring device (using the product LS-13 320 manufactured by Beckman-Coulter, Inc.). At that time, 1.359 was used as the refractive index of the ethanol, and further, a numerical value of 1.7 was used as the refractive index of the boron nitride particles. A median diameter D50 (μm) of particles which did not undergo a homogenization treatment was determined from an obtained frequency distribution of particle sizes.

### Particle Size Distribution 2

For each of the spherical boron nitride particles according to Examples 1-4 and Comparative Example 1, 0.01 g thereof was dispersed in 80 mL of ethanol and, after using an ultrasonic homogenizer (using the product US-300E manufactured by Nissei Corporation) to perform an ultrasonic dispersion at an amplitude of 70-80% for 1 minute 30 seconds, a volume-based particle size distribution was measured by a laser diffraction/scattering-method particle size distribution measuring device (using the product LS-13 320 manufactured by Beckman-Coulter, Inc.). A median diameter was calculated from the obtained volume-based particle size distribution. The median diameter is the particle diameter at a cumulative value of 50% in a cumulative particle size distribution. At that time, 1.359 was used as the refractive index of the ethanol, and further, a numerical value of 1.7 was used as the refractive index of the boron nitride particles. The results are shown in Table 1.

### Average Circularity

Image analysis software (for example, product name: “MacView” manufactured by Mountech Co., Ltd.) is used to perform image analysis on an image (magnification: 10,000×, image resolution: 1280×1024 pixels) of the boron nitride particles captured by using a scanning electron microscope (SEM), to calculate a projected area (S) and perimeter (L) of the boron nitride particles. The projected area (S) and perimeter (L) are used to determine the circularity in accordance with the following formula:

Circularity=4πS/L²

The average value of circularities determined for 100 arbitrarily selected boron nitride particles is defined as the average circularity.

### Fabrication of Resin Composition

The spherical boron nitride particles according to Examples 1-4 and Comparative Example 1 were blended in an epoxy resin as described below to fabricate resin compositions.
A dispersing agent (“DISPERBYK-111” manufactured by BYK Chemie Japan, 0.3 weight %), an SC agent (“3-Glycidyloxypropyltrimethoxysilane” manufactured by Tokyo Chemical Industry, Ltd., 1 weight %), and the respective spherical boron nitride particles according to Examples 1-4 and Comparative Example 1 (15 weight %) were added to an epoxy resin and kneaded for three minutes at an ordinary temperature, a revolution speed of 2000 rpm, and a rotation speed of 800 rpm using a hybrid mixer (“Awatori Rentaro AR-250” manufactured by Thinky Corporation). Thereafter, the mixture was kneaded twice using a three-roller miller (“BR-150V III” manufactured by Aimex Co., Ltd., gap: 10 μm, finishing roller rotation speed: 60 rpm) to obtain a resin composition.

### Thixotropy Index (T.I. Index)

For the obtained resin compositions, for viscosities at 25° C. measured, using a rheometer (“MCR92” manufactured by Anto Paar GmbH”), (1) when the shear rate is changed from 0.01 (1/s) to 100 (1/s), and (2) when the shear rate is changed from 100 (1/s) to 0.01 (1/s), a thixotropy index (T.I. index) was calculated from a value determined as a ratio (η1/η2) of a viscosity η1 measured when the shear rate is 1 (1/s) and a viscosity η2 measured when the shear rate is 10 (1/s).

TABLE 1

| | Comp Ex 1 | Ex 1 | Ex 2 | Ex 3 | Ex 4 |
|---|---|---|---|---|---|
| Times treated | 0 (untreated) | 150 | 370 | 450 | 900 |
| Rotation speed (rpm) | — | 7200 | 6000 | 7200 | 7200 |
| Device | — | JPSS | JPSS | JPSS | JPSS |
| O₁ₛ semiquantitative value | 0.5 | 0.7 | 1.1 | 0.9 | 1.4 |
| B₁ₛ semiquantitative value | 48.4 | 48.3 | 48.1 | 47.9 | 48.2 |
| B₁ₛ/O₁ₛ | 97 | 69 | 44 | 53 | 34 |
| Median diameter D50 (μm) | 35 | 19 | 28 | 21 | 25 |
| Median diameter D50 (μm) after | 0.622 | 0.549 | 0.545 | 0.543 | 0.537 |
| homogenization treatment | | | | | |
| Average circularity | 0.87 | 0.87 | 0.87 | 0.87 | 0.87 |
| (primary particle) | | | | | |
| T.I_{[0.01(1/s)→100(1/s)]} | 6.3 | 1.2 | 0.8 | 1.0 | 1.0 |
| T.I_{[100(1/s)→0.01(1/s)]} | 6.8 | 4.6 | 2.3 | 2.0 | 1.0 |

As shown in Table 1, the resin compositions including the spherical boron nitride particles according to Examples 1-4 have excellent fluidity in comparison with the resin composition including the spherical boron nitride particles according to Comparative Example 1. Surprisingly, the resin compositions including the spherical boron nitride particles according to Examples 1-4 have a characteristic wherein the thixotropy index (T.I. index) is low, being closer to one, and thus, indicating a high fluidity, not only when the shear rate was changed from a low shear rate to a high shear rate but also when the shear rate was changed from a high shear rate to a low shear rate.

### INDUSTRIAL APPLICABILITY

The spherical boron nitride particles of the present embodiment can provide a resin composition having excellent fluidity, and therefore, can be favorably used in resin compositions and fillers for resins including spherical boron nitride particles, etc., and are industrially applicable.

1. Spherical boron nitride particles having a B₁ₛ/O₁ₛ ratio of 90 or less, the B₁ₛ/O₁ₛ ratio being a ratio of a semiquantitative value calculated from an O₁ₛ peak intensity measured by X-ray photoelectron spectroscopy and a semiquantitative value calculated from a B₁ₛ peak intensity.

2. The spherical boron nitride particles according to claim 1, wherein for viscosities, measured at 25° C. with a shear rate being changed from 0.01 (1/s) to 100 (1/s), of a mixture in which 15 volume % of the spherical boron nitride particles are filled in an epoxy resin, a thixotropy index (T.I. index) represented by a ratio (η1/η2) of a viscosity η1 measured when the shear rate is 1 (1/s) and a viscosity η2 measured when the shear rate is 10 (1/s) is 2 or less.

3. The spherical boron nitride particles according to claim 1, wherein for viscosities, measured at 25° C. with a shear rate being changed from 100 (1/s) to 0.01 (1/s), of a mixture in which 15 volume % of the spherical boron nitride particles are filled in an epoxy resin, a thixotropy index (T.I. index) represented by a ratio (η1/η2) of a viscosity η1 measured when the shear rate is 1 (1/s) and a viscosity n2 measured when the shear rate is 10 (1/s) is 6 or less.

4. The spherical boron nitride particles according to claim 1, having a volume-based cumulative diameter (D50), evaluated by a laser diffraction/scattering method without performing a homogenization treatment, of 35 μm or less.

5. The spherical boron nitride particles according to claim 1, having an average circularity greater than 0.80.

6. The spherical boron nitride particles according to claim 1, wherein the semiquantitative value calculated from an O₁ₛ peak intensity measured by X-ray photoelectron spectroscopy is 0.6 or more.

7. A filler for resins, the filler comprising the spherical boron nitride particles according to claim 1.

8. A resin composition comprising a resin and the spherical boron nitride particles according to claim 1.

9. A method for producing the spherical boron nitride particles according to claim 1, the method comprising
generating cavitation bubbles in a liquid comprising raw material spherical boron nitride particles and water.
